(19) United States
(12) Patent Application Publication
(10) Pub. No.: US 2014/0200967 A1
(43) Pub. Date: Jul. 17, 2014

(54) METHOD AND SYSTEM FOR ANALYZING BRAND VALUE

(71) Applicant: MODEL IT OY, Helsinki (FI)

(72) Inventor: Osmo Visa Viktor Jauri, Kauniainen (FI)

(73) Assignee: Model IT Oy, Helsinki (FI)

(21) Appl. No.: 13/739,619

(22) Filed: Jan. 11, 2013

(51) Int. Cl. G06Q 10/06

(52) U.S. Cl. CPC G06Q 10/06375
USPC 705/7.37

(57) ABSTRACT

Systems, methods and computer program products for brand value analysis, including a brand value analysis model; and model data A and for a previous and current year, including a unit price for sold goods per volume unit (PA, PB), a number of sold goods based on volume (VA, VB), a production cost per unit CA, CB), a risk adjusted weighted average cost of capital (RAA, RAB), and a net present value multiplier associated with RAA, RAB (DA, DB). The model calculates a nominal value of future net margin cash-flows CF(A) and CF(B), a net present value of cash-flows NCF(A) and NCF(B), a nominal value of future net margin cash-flows CF(A) and CF(B), a difference NCF (B−A), and determines increase in product attractivity (PA), increase in market leadership (ML), increase in cost efficiency (CE), and increase in customer loyalty (CL), based on NCF (B−A).

### BACKGROUND OF THE INVENTION

1. Field of the Invention

The present disclosure generally relates to systems and methods for analyzing a value of a brand, and the like. More particularly, the present disclosure includes methods and systems for analyzing factors affecting a value of a brand associated with a company, and with no need to employ external information, such as market polls, surveys, and the like, and including determining factors that drive brand value changes, measuring changes thereof over time, and the like.

2. Discussion of the Background

In recent years, systems and methods have been developed for brand value analysis. However, traditionally, in such systems and methods the brand value of a company is divided into components buy using external information, and the like.

Therefore, there is a need for systems and methods for brand value analysis that do not suffer from the above and other problems related to conventional system and methods.

### SUMMARY OF THE INVENTION

The above and other needs are addressed by embodiments of the present disclosure, which provide systems, methods and computer program products for brand value analysis, including the analysis of single products, product portfolios in one period or multiple periods. The systems, methods and computer program products can be configured for dividing brand value changes into understandable components, analytically, and without using such external information. The systems, methods and computer program products can be configured for dividing brand value changes, and the like, into factors, and the like, and defining the effect of each factor separately, and the like. In another aspect, the systems, methods and computer program products can be configured for analyzing brand values without using market surveys, including interviews, surveys, polls, and the like. Advantageously, companies are able to measure the components that explain differences or changes in brand value between different financial years, strategies, budgets or other plans.

Accordingly, in illustrative aspects, systems, methods and computer program products for brand value analysis are provided, including a brand value analysis model; and model data A based on annual financial information of a brand for a previous year, and model data B based on forecasted annual financial information of the brand for a current year. The financial information can include a unit price for sold goods per volume unit (P_{A}, P_{B}), a number of sold goods based on volume (V_{A}, V_{B}), a production cost per unit C_{A}, C_{B}), a risk adjusted weighted average cost of capital (RA_{A}, RA_{B}), and a net present value multiplier associated with RA_{A}, RA_{B} (D_{A}, D_{B}). The brand value analysis model can calculate a nominal value of future net margin cash-flows CF(A) based on P_{A}, C_{A}, and V_{A}, and CF(B) based on P_{B}, C_{B} and V_{B}. The brand value analysis model can calculate a net present value of cash-flows NCF(A) based on P_{A}, C_{A}, V_{A}, and D_{A}, and NCF(B) based on P_{B}, C_{B}, V_{B}, and D_{B}. The brand value analysis model can calculate a nominal value of future net margin cash-flows CF(A) based on P_{A}, C_{A}, and V_{A}, and CF(B) based on P_{B}, C_{B} and V_{B}. The brand value analysis model can calculate a difference between NCF(A) and NCF(B), as NCF (B-A) based on NCF(A) and NCF(B). The brand value analysis model can determine increase in product attractivity (PA), increase in market leadership (ML), increase in cost efficiency (CE), and increase in customer loyalty (CL), based on NCF (B-A). The calculated and determined results can be displayed to a user.

The brand value analysis model can be configured for one period or multi-period analysis, one product or multi-product analysis, and fixed costs or no fixed costs analysis.

Still other aspects, features, and advantages of the present disclosure are readily apparent from the following detailed description, simply by illustrating a number of illustrative embodiments and implementations, including the best mode contemplated for carrying out the present disclosure. The present disclosure is also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIG. 1 is a numerical illustration of a base case referred to in illustrative equations 15-18 for systems and methods for brand value analysis; and

FIG. 2 is an illustrative flowchart of illustrative calculation steps for systems and methods for brand value analysis.

### DETAILED DESCRIPTION OF THE INVENTION

Systems and methods for brand value analysis are described. In the following description, for purposes of explanation, numerous specific details are set forth in order to provide thorough understanding of the present invention. It is apparent to one skilled in the art, however, that the present innovation can be predicted without these specific details or with equivalent arrangement. In some instances, well-known structures and devices are shown in figures and diagrams in order to avoid unnecessarily obscuring the present invention.

In the context of the present disclosure, external information can include any suitable information about a brand or a brand value, and the like, obtained from sources external to a company in question, and the like. Examples of such external information sources can include, for example, market polls, surveys, and the like, where consumers or other persons express their opinions and such information is collected in some form for further analysis, and the like. In the context of the present disclosure, information about yield curves, and the like, is not considered external information.

The present disclosure includes recognition that collecting such external information may be unreliable, expensive, time consuming, and the like, and therefore, there is a need for a method and system for analyzing changes in brand value without using such external information. The present disclosure further includes recognition that a company's brand value can be determined by applying financial formulas to define brand value. Commonly, brand value can be determined based on financial formulas, such as:

Brand Value=Net present value of company's future cash-flows
Capital invested in operations
Value of transferable patents and other immaterial rights

In the context of the present disclosure, brand value can include all suitable immaterial, non-transferable, and the like, value of a company, and the like. In further contexts, brand value can include narrower content, for example, being defined not to include values associated with existing customer relationships, and the like, even if in many cases creation of customer relationships, associated documentation, contracts, and the like, carry substantial costs, and the like. The present disclosure provides a system and method for dividing brand value into components giving decision maker better and more complete information. The present disclosure is general and it is not limited to any particular way of determining brand value and the formula presented for Brand Value above is only an example for illustrative purposes.

The net present value of company's future cash-flows is commonly derived by estimating future cash-flows and by discounting cash flows with appropriate discount rate. In many cases, the discount rate is defined to be weighted average cost of capital (WACC). The WACC term is commonly defined as a weighted average of debt and equity costs. Weights can be determined many ways, commonly by taking volumes from current balance sheet, but weights can equally reflect planned debt/equity ratio of a new investment or they can be measured from stock market beta-values. The presented invention is not limited to any particular method for determining WACC, but can be applied regardless of the underlying methodology.

Risk Adjusted Weighted Cost of Capital (RAWACC) is a term that refers to analysis, where the level of WACC is determined based on risks associated to assumed cash-flows. As an example for illustrative purposes, RAWACC can be based on stock market beta in a companywide analysis, or might be based on volatility or other measures of randomness. One example of such measure is standard deviation (e.g., volatility) of monthly sales, volume or dollars. The present disclosure utilizes the concept of RAWACC, but is not limited to any particular method to observe or define RAWACC.

The principal of this method can be applied to a single product, to a group of products or to company level, and the like. The present disclosure can be used to compare different plans or time periods, with realized, forecasted or planned data. The present disclosure first presents a single period analysis where two alternative plans are compared. Thereafter, it is shown how the present disclosure can be applied to multiple periods and different time horizons.

Single period model. Two alternative strategies are compared. The reference plan (or e.g., strategy) is referred as Case A and the alternative plan is referred as Case B. In this illustration, produced are one sellable good and all production costs are volume depending. In Case B, defined are an alternative plan where introduced are changes to prices, production costs, volumes and uncertainty. The difference in risk adjusted net present values between the two alternative is obtained by discounting the cash-flows with risk adjusted weighted cost of capital.

The following notation is used:

Unit price for sold goods per volume unit: P_{A},P_{B} (Eq. 01)

Number of sold goods(e.g., volume): V_{A},V_{B} (Eq. 02)

Production cost per unit: C_{A},C_{B} (Eq. 03)

Risk adjusted weighted average cost of capital: RA_{A},RA_{B} (Eq. 04)

Net present value multiplier associated with RA_{A},RA_{B}: D_{A},D_{B} (Eq. 05)

With the given notation the nominal value of future net margin cash-flows (CF) for Case A can be written as:

CF(A)=(P_{A}−C_{A})V_{A} (Eq. 06)

and equally for Case B:

CF(B)=(P_{B}−C_{B})V_{B} (Eq. 07)

The net present value of these cash-flows (NCF) are computed by multiplying the cash-flows with associates discounting factors:

NCF(A)=(P_{A}−C_{A})V_{A}D_{A} (Eq. 08)

and

NCF(B)=(P_{B}−C_{B})V_{B}D_{B} (Eq. 09)

The difference between the two terms, the change in net asset value of net margin cash-flows, is given by:

NCF(B−A)=NCF(B)−NCF(A)=(P_{B}−C_{B})V_{B}D_{B}−(P_{A}−C_{A})V_{A}D_{A} (Eq. 10)

This can be written open as:

NCF(B−A)=P_{B}V_{B}D_{B}−C_{B}V_{B}D_{B}−P_{A}V_{A}D_{A}+C_{A}V_{A}D_{A} (Eq. 11)

The formula above for NCF(B−A) is now expanded by adding new terms both with addition and deduction:

$$NCF ( B - A ) = {P}_{B} {V}_{B} {D}_{ B} - {C}_{B} {V}_{B} {D}_{B} - {P}_{A} {V}_{A} {D}_{A} + {C}_{A } {V}_{A} {D}_{A} + {P}_{B} {V}_{A} {D}_{A} - {P}_{B} {V}_{A} {D}_{A} + {V}_{B} {P}_{B } {D}_{A} - {V}_{B} {P}_{B} {D}_{A} + {V}_{A} {C}_{B} {D}_{A} - {V}_{A} {C}_{B} {D}_{A} + {C}_{B} {V}_{B} {D}_{A} - {V}_{B} {C}_{B} {D}_{A} \qquad ( Eq . 12 )$$

By rearranging terms:

$$NCF ( B - A ) = {V}_{B} {P}_{B} {D}_{A} - {V}_{A} {P}_{B} {D}_{A} + {V}_{A} {C}_{B} {D}_{A} - {V}_{B} {C}_{B} {D}_{A} + {P}_{B} {V}_{A} {D}_{A} - {P}_{A} {V}_{A} {D}_{A} + {C}_{A} {V}_{A} {D}_{A} - {C}_{B} {V}_{A} {D}_{A} + {P}_{B} {V}_{B } {D}_{B} - {P}_{B} {V}_{B} {D}_{A} - {C}_{B} {V}_{B} {D}_{B} + {C}_{B} {V}_{B} {D}_{A} \qquad ( Eq . 13 )$$

and simplifying yields:

discounted value of volume change: NCF(B−A)=(V_{B}−V_{A})(P_{B}−C_{B})D_{A} (Eq. 14)

discounted value of price change: +(P_{B}−P_{A})V_{A}D_{A}

discounted value of cost level change: +(C_{A}−C_{B})V_{A}D_{A}

value of change in discounting factor: +(P_{B}−C_{B})V_{B}(D_{B}−D_{A})

In the first line, the change in volume is multiplied with net margin and then with discounting factor giving the NPV of increased margin due to increased volume. In the second line, the change in prices is multiplied with original volume and finally with discounting factor giving the NPV of increased prices with original volume. In the third line, the change in production costs is multiplied with original volume and with discounting factor giving the NPV of decreased production cost In the fourth line, the Case B net margin per unit is multiplied with case B volume and with the change of the discounting factor giving the net present value of discounting factor change.

These components have a clear interpretation in brand value analysis: (1) Increase in Product Attractivity (PA) can be measured from volume increase; (2) Increase in Market Leadership (ML) can be measured from unit price increase; (3) Increase in Cost Efficiency (CE) can be measured from production unit cost decrease and change in other expenses; and (4) Increase in Customer Loyalty (CL) can be measured from increased risk adjusted net present values as they reflect decreased uncertainty of future cash-flows.

Now the difference of net present values of two alternative plans A and B can be divided into four components:

Increase in Product Attractivity: PA=(V_{B}−V_{A})(P_{B}−C_{B})D_{A} (Eq. 15)

Increase in Market Leadership: ML=(P_{B}−P_{A})V_{A}D_{A} (Eq. 16)

Increase in Cost Efficiency: CE=(C_{A}−C_{B})V_{A}D_{A} (Eq. 17)

Increase in Customer Loyalty: CL=(P_{B}−C_{B})V_{B}(D_{B}−D_{A}) (Eq. 18)

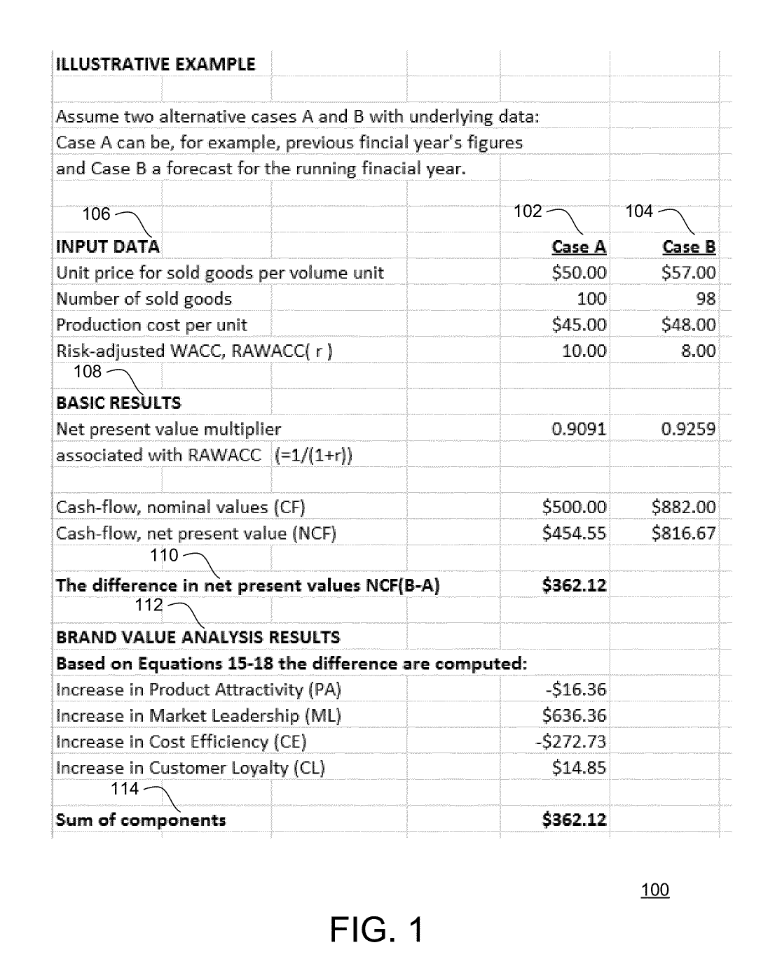

A numerical example for illustration is exhibited in the table of FIG. 1, as further described.

Extension 1: How to take into account fixed costs. The following notation is used:

Unit price for sold goods per volume unit: P_{A},P_{B} (Eq. 19)

Number of sold goods(volume): V_{A},V_{B} (Eq. 20)

Production cost per unit: C_{A},C_{B} (Eq. 21)

Other expenses, total in dollars E_{A},E_{B} (Eq. 22)

Risk adjusted weighted average cost of capital: RA_{A},RA_{B} (Eq. 23)

Net present value multiplier associated with RA_{A},RA_{B}: D_{A},D_{B} (Eq. 24)

With the given notation the nominal value of future net margin cash-flows (CF) for Case A can be written as:

CF(A)=(P_{A}−C_{A})V_{A}−E_{A} (Eq. 25)

and equally for Case B:

CF(B)=(P_{B}−C_{B})V_{B}−E_{A} (Eq. 26)

The net present value of these cash-flows (NCF) are computed by multiplying the cash-flows with associates discounting factors:

NCF(A)−((P_{A}−C_{A})V_{A}−E_{A})D_{A} (Eq. 27)

and

NCF(B)=((P_{B}−C_{B})V_{B}−E_{B})D_{B} (Eq. 28)

The difference between the two terms, the change in net asset value of net margin cash-flows, is given by:

$$\begin{matrix}NCF ( B - A ) = NCF ( B ) - NCF ( A ) \\ = ( ( {P}_{B} - {C}_{B} ) {V}_{B } - {E}_{B} ) {D}_{B} - ( ( {P}_{A} - {C}_{A} ) {V}_{A} - {E}_{A} ) {D}_{A}\end{matrix} \qquad ( Eq . 29 )$$

This can be written open as:

$$NCF ( B - A ) = {P}_{B} {V}_{B} {D}_{B} - {C}_{B} {V}_{B} {D}_{B} - {P}_{A} {V}_{A} {D}_{A} + {C}_{A} {V}_{A} {D}_{A} + {E}_{A} {D}_{A} - {E}_{B} {D}_{B} \qquad ( Eq . 30 )$$

The formula above for NCF(B−A) is now expanded by adding new terms both with addition and deduction:

$$NCF ( B - A ) = {P}_{B} {V}_{B} {D}_{B} - {C}_{B} {V}_{B} {D}_{B} - {P}_{A} {V}_{A} {D}_{A} + {C}_{A} {V}_{A} {D}_{A} + {E}_{A} {D}_{A} - {E}_{B} {D}_{B} + {P}_{B} {V}_{A} {D}_{A} - {P}_{B} {V}_{A} {D}_{A} + {V}_{B} {P}_{B} {D}_{A} - {V}_{B} {P}_{B} {D}_{A} + {V}_{A} {C}_{B} {D}_{A} - {V}_{A} {C}_{B} {D}_{A} + {C}_{B} {V}_{B} {D}_{A} - {V}_{B} {C}_{B} {D}_{A} \qquad ( Eq . 31 )$$

By rearranging terms:

$$NCF ( B - A ) = {V}_{B} {P}_{B} {D}_{A} - {V}_{A} {P}_{B} {D}_{A} + {V}_{A} {C}_{B} {D}_{A} - {V}_{B} {C}_{B} {D}_{A} + {P}_{B} {V}_{A} {D}_{A} - {P}_{A} {V}_{A} {D}_{A} + {C}_{A} {V}_{A} {D}_{A} - {C}_{B} {V}_{A} {D}_{A} + {P}_{B} {V}_{B} {D}_{B} - {P}_{B } {V}_{B} {D}_{A} - {C}_{B} {V}_{B} {D}_{B} + {C}_{B} {V}_{B} {D}_{A} + {E}_{A} {D}_{A} - {E}_{B} {D}_{B} \qquad ( Eq . 32 )$$

and simplifying yields:

discounted value of volume change: NCF(B−A)=(V_{B}−V_{A})(P_{B}−C_{B})D_{A} (Eq. 33)

discounted value of price change: +(P_{B}−P_{A})V_{A}D_{A}

discounted value of cost level change: +(C_{A}−C_{B})V_{A}D_{A}

value of change in discounting factor: +(P_{B}−C_{B})V_{B}(D_{B}−D_{A})

the value of change in fixed expenses: ±E_{A}D_{A}−E_{B}D_{B}

In the first line, the change in volume is multiplied with net margin and then with discounting factor giving the NPV of increased margin due to increased volume. In the second line, the change in prices is multiplied with original volume and finally with discounting factor giving the NPV of increased prices with original volume. In the third line, the change in production costs is multiplied with original volume and with discounting factor giving the NPV of decreased production cost. In the fourth line, the Case B net margin per unit is multiplied with case B volume and with the change of the discounting factor giving the net present value of discounting factor change. In the fifth line, the difference in risk adjusted net present value of expenses is shown.

These components have a clear interpretation in brand value analysis: (1) Increase in Product Attractivity (PA) can be measured from volume increase; (2) Increase in Market Leadership (ML) can be measured from unit price increase; (3) Increase in Cost Efficiency (CE) can be measured from production unit cost decrease and change in other expenses; (4) Increase in Customer Loyalty (CL) can be measured from increased risk adjusted net present values as they reflect decreased uncertainty of future cash-flows; and (5) Change in fixed expenses (FE) is computed separately to enable verification against change in total net present value. FE component has no interpretation for brand value analysis, but is shown for technical completeness.

Now the difference of net present values of two alternative plans A and B can be divided into five components:

Increase in Product Attractivity: PA=(V_{B}−V_{A})(P_{B}−C_{B})D_{A} (Eq. 34)

Increase in Market Leadership: ML=(P_{B}−P_{A})V_{A}D_{A} (Eq. 35)

Increase in Cost Efficiency: CE=(C_{A}−C_{B})V_{A}D_{A} (Eq. 36)

Increase in Customer Loyalty: CL=(P_{B}−C_{B})V_{B}(D_{B}−D_{A}) (Eq. 37)

Change in Fixed Expenses: FE=E_{A}D_{A}−E_{B}D_{B} (Eq. 38)

Extension 2: Multiperiodic analysis. Case A and Case B are extended to include several periods i=1 . . . N, and all variables are defined separately for each period. The following notation is used for period i:

Unit price for sold goods per volume unit: P_{A,i},P_{B,i} (Eq. 39)

Number of sold goods(volume): V_{A,i},V_{B,i} (Eq. 40)

Production cost per unit: C_{A,i},C_{B,i} (Eq. 41)

Risk adjusted weighted average cost of capital: RA_{A,i},RA_{B,i} (Eq. 42)

Net present value multiplier associated with RA_{A,i},RA_{B,i}:D_{A,i},D_{B,i} (Eq. 43)

With the given notation the nominal value of future net margin cash-flows over multiple periods (MPNCF) for Case A can be written as:

$$MPCF ( A ) = {\sum }_{i = 1}^{N} [ ( {P}_{A , i} - {C}_{A , i} ) {V}_{A , i} ] \qquad ( Eq . 44 )$$

and equally for Case B:

$$MPCF ( B ) = {\sum }_{i = 1}^{N} [ ( {P}_{B , i} - {C}_{B , i} ) {V}_{B , i} ] \qquad ( Eq . 45 )$$

The net present value of these multi-period cash-flows (MPNCF) are computed by multiplying the cash-flows with associates discounting factors:

$$\begin{matrix}MPNCF ( A ) = {\sum }_{i = 1}^{N} [ ( {P}_{A , i} - {C}_{A , i} ) {V}_{A , i} {D}_{A , i} ] \\ and & ( Eq . 46 ) \\ MPNCF ( B ) = {\sum }_{i = 1}^{N} [ ( {P}_{B , i} - {C}_{B , i} ) {V}_{B , i} {D}_{B , i} ] & ( Eq . 47 )\end{matrix}$$

The difference between the two terms, the change in net asset value of net margin cash-flows, is given by:

$$\begin{matrix}MPNCF ( B - A ) = MPNCF ( B ) - MPNCF ( A ) \\ = {\sum }_{i = 1}^{N} [ \begin{matrix}( {P}_{B , i} - {C}_{B , i} ) {V}_{B , i} {D}_{B , i} - \\ ( {P}_{A , i} - {C}_{A , i} ) {V}_{A , i} {D}_{A , i}\end{matrix} ]\end{matrix} \qquad ( Eq . 48 )$$

This can be written open as:

$$MPNCF ( B - A ) = {\sum }_{i = 1}^{N} [ \begin{matrix}{P}_{B , i} {V}_{B , i} {D}_{B , i} - {C}_{B , i} {V}_{B , i} {D}_{B , i} - \\ {P}_{A , i} {V}_{A , i} {D}_{A , i} + {C}_{A , i} {V}_{A , i} {D}_{A , i}\end{matrix} ] \qquad ( Eq . 49 )$$

This formula is now expanded by adding new terms both with addition and deduction:

$$MPNCF ( B - A ) = {\sum }_{i = 1}^{N} [ \begin{matrix}\begin{matrix}\begin{matrix}\begin{matrix}{P}_{B , i} {V}_{B , i} {D}_{B , i} - {C}_{B , i} {V}_{B , i} {D}_{B , i} - \\ {P}_{A , i} {V}_{A , i} {D}_{A , i} + {C}_{A , i} {V}_{A , i} {D}_{A , i} +\end{matrix} \\ {P}_{B , i} {V}_{A , i} {D}_{A , i} - {P}_{B , i} {V}_{A , i} {D}_{A , i} +\end{matrix} \\ {V}_{B , i} {P}_{B , i} {D}_{A , i} - {V}_{B , i} {P}_{B , i} {D}_{A , i} +\end{matrix} \\ {V}_{A , i} {C}_{B , i} {D}_{A , i} - {V}_{A , i} {C}_{B , i} {D}_{A , i} + \\ {C}_{B , i} {V}_{B , i} {D}_{A , i} - {V}_{B , i} {C}_{B , i} {D}_{A , i}\end{matrix} ] \qquad ( Eq . 50 )$$

By rearranging terms:

$$MPNCF ( B - A ) = {\sum }_{i = 1}^{N} [ \begin{matrix}\begin{matrix}\begin{matrix}\begin{matrix}\begin{matrix}{V}_{B , i} {P}_{B , i} {D}_{A , i} - {V}_{A , i} {P}_{B , i} {D}_{A , i} + \\ {V}_{A , i} {C}_{B , i} {D}_{A , i} - {V}_{B , i} {C}_{B , i} {D}_{A , i} +\end{matrix} \\ {P}_{B , i} {V}_{A , i} {D}_{A , i} - {P}_{A , i} {V}_{A , i} {D}_{A , i} +\end{matrix} \\ {C}_{A , i} {V}_{A , i} {D}_{A , i} - {C}_{B , i} {V}_{A , i} {D}_{A , i} +\end{matrix} \\ {P}_{B , i} {V}_{B , i} {D}_{B , i} - {P}_{B , i} {V}_{B , i} {D}_{A , i} -\end{matrix} \\ {C}_{B , i} {V}_{B , i} {D}_{B , i} + {C}_{B , i} {V}_{B , i} {D}_{A , i}\end{matrix} ] \qquad ( Eq . 51 )$$

and simplifying yields:

$$MPNCF ( B - A ) = {\sum }_{i = 1}^{N} [ ( {V}_{B , i} - {V}_{A , i} ) ( {P}_{B , i} - {C}_{B , i} ) {D}_{A , i} ] + {\sum }_{i = 1}^{N} [ ( {P}_{B , i} - {P}_{A , i} ) {V}_{A , i} {D}_{A , i} ] + {\sum }_{i = 1}^{N} [ ( {C}_{A , i} - {C}_{B , i} ) {V}_{A , i} {D}_{A , i} ] + {\sum }_{i = 1}^{N} [ ( {P}_{B , i} - {C}_{B , i} ) {V}_{B , i} ( {D}_{B , i} - {D}_{A , i} ) ] \qquad ( Eq . 52 )$$

with equal interpretations as in equations 1-5.

Now the difference of net present values of two alternative plans A and B can be divided into four components:

Increase in Product Attractivity:

$$PA = {\sum }_{i = 1}^{N} [ ( {V}_{B , i} - {V}_{A , i} ) ( {P}_{B , i} - {C}_{B , i} ) {D}_{A , i} ] \qquad ( Eq . 53 )$$

Increase in Market Leadership:

$$ML = {\sum }_{i = 1}^{N} [ ( {P}_{B , i} - {P}_{A , i} ) {V}_{A , i} {D}_{A , i} ] \qquad ( Eq . 54 )$$

Increase in Cost Efficiency:

$$CE = {\sum }_{i = 1}^{N} [ ( {C}_{A , i} - {C}_{B , i} ) {V}_{A , i} {D}_{A , i} ] \qquad ( Eq . 55 )$$

Increase in Customer Loyalty:

$$CL = {\sum }_{i = 1}^{N} [ ( {P}_{B , i} - {C}_{B , i} ) {V}_{B , i} ( {D}_{B , i} - {D}_{A , i} ) ] \qquad ( Eq . 56 )$$

Extension 3: Multiproduct and multiperiodic analysis. Case A and Case B are extended to include several periods i=1 . . . N, and several products j=1 . . . M. All variables are defined separately for each period i and product j. The following notation is used:

Unit price for sold goods per volume unit: P_{A,i,j}P_{B,i,j} (Eq. 57)

Number of sold goods(volume): V_{A,i,j},V_{B,i,j} (Eq. 58)

Production cost per unit: C_{A,i,j},C_{B,i,j} (Eq. 59)

Risk adjusted weighted average cost of capital: RA_{A,i},RA_{B,i} (Eq. 60)

Net present value multiplier associated with RA_{A,i},RA_{B,i}:D_{A,i},D_{B,i} (Eq. 61)

With the given notation the nominal value of future net margin cash-flows over all periods and products (MPPCF) for Case A can be written as:

$$MPPCF ( A ) = {\sum }_{i = 1}^{N} {{\sum }_{j = 1}}^{M} [ ( {P}_{A , i , j} - {C}_{A , i , j} ) {V}_{A , i , j} ] \qquad ( Eq . 62 )$$

and equally for Case B:

$$MPPCF ( B ) = {\sum }_{i = 1}^{N} {{\sum }_{j = 1}}^{M} [ ( {P}_{B , i , j} - {C}_{B , i , j} ) {V}_{B , i , j} ] \qquad ( Eq . 63 )$$

The net present value of these multi-period cash-flows (MPPNCF) are computed by multiplying the cash-flows with associates discounting factors:

$$\begin{matrix}MPPNCF ( A ) = {\sum }_{i = 1}^{N} {{\sum }_{j = 1}}^{M} [ ( {P}_{A , i , j} - {C}_{A , i , j} ) {V}_{A , i , j} ] {D}_{A , i} \\ and & ( Eq . 64 ) \\ MPPNCF ( B ) = {\sum }_{i = 1}^{N} {{\sum }_{j = 1}}^{M} [ ( {P}_{B , i , j} - {C}_{B , i , j} ) {V}_{B , i , j} ] {D}_{B , i} & ( Eq . 65 )\end{matrix}$$

The difference between the two terms, the change in net asset value of net margin cash-flows, is given by:

$$\begin{matrix}MPPNCF ( B - A ) = MPPNCF ( B ) - MPPNCF ( A ) \\ = {{\sum }_{i = 1}}^{N} {{\sum }_{j = 1}}^{M} [ \begin{matrix}( {P}_{B , i , j} - {C}_{B , i , j} ) {V}_{B , i , j} {D}_{B , i} - \\ ( {P}_{A , i , j} - {C}_{A , i , j} ) {V}_{A , i , j} {D}_{A , i}\end{matrix} ]\end{matrix} \qquad ( Eq . 66 )$$

This can be written open as:

$$MPPNCF ( B - A ) = {{\sum }_{i = 1}}^{N} {{\sum }_{j = 1}}^{M} [ \begin{matrix}{P}_{B , i , j} {V}_{B , i , j} {D}_{B , i} - {C}_{B , i , j} {V}_{B , i , j} {D}_{B , i} - \\ {P}_{A , i , j} {V}_{A , i , j} {D}_{A , i} + {C}_{A , i , j} {V}_{A , i , j} {D}_{A , i}\end{matrix} ] \qquad ( Eq . 67 )$$

This formula is now expanded by adding new terms both with addition and deduction:

$$MPPNCF ( B - A ) = {{\sum }_{i = 1}}^{N} {{\sum }_{j = 1}}^{M} [ {P}_{B , i , j} {V}_{B , i , j} {D}_{B , i} - {C}_{B , i , j} {V}_{B , i , j} {D}_{B , i} - {P}_{A , i , j} {V}_{A , i , j} {D}_{A , i} + {C}_{A , i , j} {V}_{A , i , j} {D}_{A , i} + {P}_{B , i , j} {V}_{A , i , j} {D}_{A , i} - {P}_{B , i , j} {V}_{A , i , j} {D}_{A , i} + {V}_{B , i , j} {P}_{B , i , j} {D}_{A , i} - {V}_{B , i , j} {P}_{B , i , j} {D}_{A , i} + {V}_{A , i , j} {C}_{B , i , j} {D}_{A , i} - {V}_{A , i , j} {C}_{B , i , j} {D}_{A , i} + {C}_{B , i , j} {V}_{B , i , j} {D}_{A , i} - {V}_{B , i , j} {C}_{B , i , j} {D}_{A , i} ] \qquad ( Eq . 68 )$$

By rearranging terms:

$$MPPNCF ( B - A ) = {{\sum }_{i = 1}}^{N} {{\sum }_{j = 1}}^{M} [ {V}_{B , i , j} {P}_{B , i , j} {D}_{A , i} - {V}_{A , i , j} {P}_{B , i , j} {D}_{A , i} + {V}_{A , i , j} {C}_{B , i , j} {D}_{A , i} - {V}_{B , i , j} {C}_{B , i , j} {D}_{A , i} + {P}_{B , i , j} {V}_{A , i , j} {D}_{A , i} - {P}_{A , i , j} {V}_{A , i , j} {D}_{A , i} + {C}_{A , i , j} {V}_{A , i , j} {D}_{A , i} - {C}_{B , i , j} {V}_{A , i , j} {D}_{A , i} + {P}_{B , i , j} {V}_{B , i , j} {D}_{B , i} - {P}_{B , i , j} {V}_{B , i , j} {D}_{A , i} - {C}_{B , i , j} {V}_{B , i , j} {D}_{B , i} + {C}_{B , i , j} {V}_{B , i , j} {D}_{A , i} ] \qquad ( Eq . 69 )$$

and simplifying yields:

$$MPPNCF ( B - A ) = {{\sum }_{i = 1}}^{N} {{\sum }_{j = 1}}^{M} [ ( {V}_{B , i , j} - {V}_{A , i , j} ) ( {P}_{B , i , j} - {C}_{B , i , j} ) {D}_{A , i} ] + {{\sum }_{i = 1}}^{N} {{\sum }_{j = 1}}^{M} [ ( {P}_{B , i , j} - {P}_{A , i , j} ) {V}_{A , i , j} {D}_{A , i} ] + {{\sum }_{i = 1}}^{N} {{\sum }_{j = 1}}^{M} [ ( {C}_{A , i , j} - {C}_{B , i , j} ) {V}_{A , i , j} {D}_{A , i} ] + {{\sum }_{i = 1}}^{N} {{\sum }_{j = 1}}^{M} [ ( {P}_{B , i , j} - {C}_{B , i , j} ) {V}_{B , i , j} ( {D}_{B , i} - {D}_{A , i} ) ] \qquad ( Eq . 70 )$$

with equal interpretations as in equations 11-14.

Now the difference of net present values of two alternative plans A and B can be divided into four components:

Increase in Product Attractivity:

$$PA = {\sum }_{i = 1}^{N} {{\sum }_{j = 1}}^{M} [ ( {V}_{B , i , j} - {V}_{A , i , j} ) ( {P}_{B , i , j} - {C}_{B , i , j} ) {D}_{A , i} ] \qquad ( Eq . 71 )$$

Increase in Market Leadership:

$$ML = {\sum }_{i = 1}^{N} {{\sum }_{j = 1}}^{M} [ ( {P}_{B , i , j} - {P}_{A , i , j} ) {V}_{A , i , j} {D}_{A , i} ] \qquad ( Eq . 72 )$$

Increase in Cost Efficiency:

$$CE = {\sum }_{i = 1}^{N} {{\sum }_{j = 1}}^{M} [ ( {C}_{A , i , j} - {C}_{B , i , j} ) {V}_{A , i , j} {D}_{A , i} ] \qquad ( Eq . 73 )$$

Increase in Customer Loyalty:

$$CL = {\sum }_{i = 1}^{N} {{\sum }_{j = 1}}^{M} [ ( {P}_{B , i , j} - {C}_{B , i , j} ) {V}_{B , i , j} ( {D}_{B , i} - {D}_{A , i} ) ] \qquad ( Eq . 74 )$$

Accordingly, systems and methods for analyzing changes in net present values of different financial plans or results are provided, in particular in the context of dividing these changes into components that have brand value related interpretations. Numerous modifications can be made to adjust the model to various situations. There principal modifications are presented: one to account for fixed costs, one for multiperiodic analysis and one for multiperiodic and multiproduct analysis. Extensions are examples of modifications that can be easily made to account for case details. It is apparent to one skilled in the art, however, how to develop such modifications based on the three principal modifications shown in the documentation.

FIG. 1 is a numerical illustration 100 of a base case referred to in illustrative equations 15-18 for systems and methods for brand value analysis. In FIG. 1, presented is a numerical example 100 for case A at column 102 (e.g., previous financial year figures) and case B (e.g., forecast of ongoing financial year figures) at column 104 to demonstrate how the system and method of present disclosure are used. The elements can include data 106 about sales volume, prices and production costs, and risk adjusted weighted average cost of capital (WACC) and the corresponding formulas, RAWACC (r), that provide results for cases A and B. Basic results are shown at 108 used to calculate the difference in net present values, NCF (B−A) at 110. Brand value analysis results based on equations (15)-(18) are shown at 112, with the sum of the various components 114, for determining the brand value.

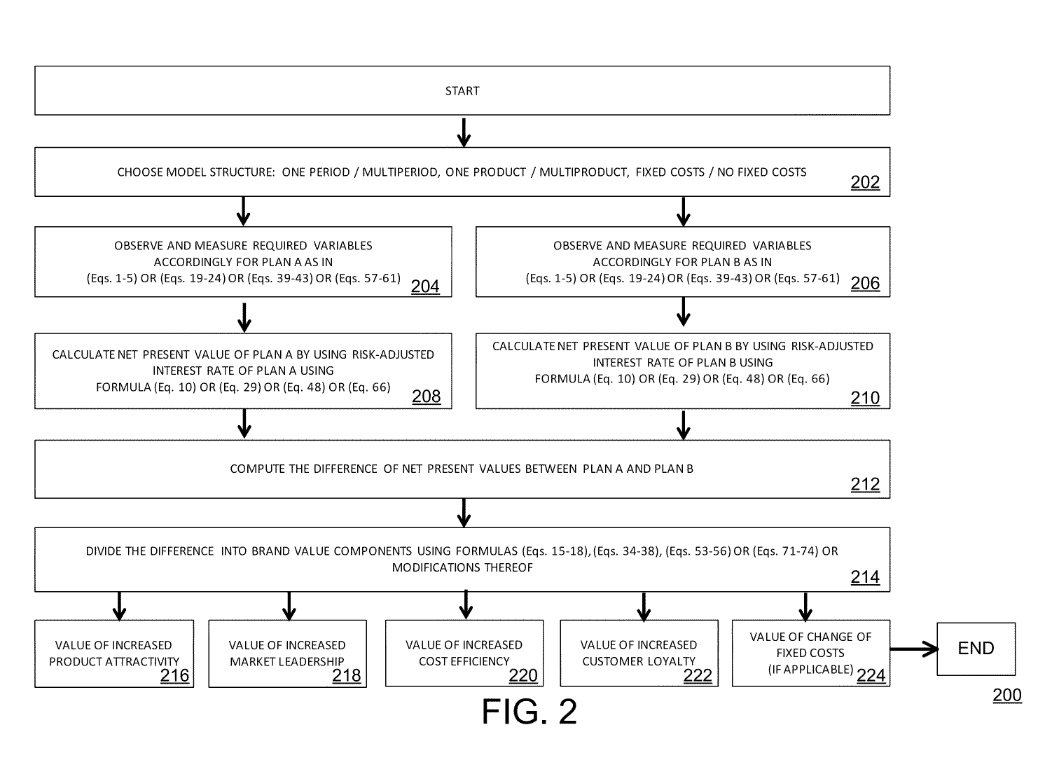

FIG. 2 is an illustrative flowchart 200 of illustrative calculation steps for systems and methods for brand value analysis. In FIG. 2, presented are the steps and tasks to be taken to utilize the system and method of present disclosure. In the context of financial planning, the model can be rerun several times for computing desired results. At step 202, a model is selected (e.g., one period/multi-period, one product/multi-product, fixed costs/no fixed costs). At steps 204 and 206, respective cases A and B are analyzed using equations (1)-(5) or (19)-(24) or (39)-(43) or (57-61), as needed. At steps 208 and 210, respective cases A and B are analyzed using equations (10) or (29) or (48) or (66), as needed. At step 212, the difference in net present value is calculated based on the results of steps 208 and 210 for cases A and B, respectively. At step 214, the difference calculated in step 212 is divided into the various brand value components using equations (15)-(18) or (34)-(38) or (53)-(56) or (71-74), as needed. At steps 216-224 the respective results of step 214 can be displayed to a user, completing the process.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present disclosure. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present disclosure, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present disclosure can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementing the inventions. Computer code devices of the illustrative embodiments of the present disclosure can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present disclosure can be distributed for better performance, reliability, cost, and the like.

As stated above, the devices and subsystems of the illustrative embodiments can include computer readable medium or memories for holding instructions programmed according to the teachings of the present disclosure and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The system and method of present disclosure are presented in the context of comparing two alternative plans just for simplification of matters. The system and method of present disclosure can be extended for analyzing and comparing any suitable number of alternative plans or realizations, as will be appreciated by those of ordinary skill in the relevant art(s).

Thus systems, methods and computer program products are provided for analyzing changes in net present values of financial plans and results, especially in the context of analyzing factors that can be interpreted as brand value components. Extensions to basic model to take into account multiple products, multiple periods and different cost structures, and the like, are readily apparent, based on the present disclosure, as will be appreciated by those of ordinary skill in the relevant art(s).

While the present disclosure has been described in connection with a number of illustrative embodiments, and implementations, the present disclosure is not so limited, but rather covers various modifications, and equivalent arrangements, which fall within the purview of the appended claims.

What is claimed is:

1. A computer implemented system for brand value analysis, the system comprising:
a brand value analysis model; and
model data A based on annual financial information of a brand for a previous year, and model data B based on forecasted annual financial information of the brand for a current year, wherein the financial information includes a unit price for sold goods per volume unit (P_{A}, P_{B}), a number of sold goods based on volume (V_{A}, V_{B}), a production cost per unit C_{A}, C_{B}), a risk adjusted weighted average cost of capital (RA_{A}, RA_{B}), and a net present value multiplier associated with RA_{A}, RA_{B} (D_{A}, D_{B}),
the brand value analysis model is configured to calculate a nominal value of future net margin cash-flows CF(A) based on P_{A}, C_{A}, and V_{A}, and CF(B) based on P_{B}, C_{B} and V_{B},
the brand value analysis model is configured to calculate a net present value of cash-flows NCF(A) based on P_{A}, C_{A}, V_{A}, and D_{A}, and NCF(B) based on P_{B}, C_{B}, V_{B}, and D_{B},
the brand value analysis model is configured to calculate a nominal value of future net margin cash-flows CF(A) based on P_{A}, C_{A}, and V_{A}, and CF(B) based on P_{B}, C_{B} and V_{B},
the brand value analysis model is configured to calculate a difference between NCF(A) and NCF(B), as NCF (B−A) based on NCF(A) and NCF(B),
the brand value analysis model is configured to determine increase in product attractivity (PA), increase in market leadership (ML), increase in cost efficiency (CE), and increase in customer loyalty (CL), based on NCF (B−A),
wherein the system is configured to display to a user the calculated and determined results.

2. The system of claim 1, wherein the brand value analysis model is configured for one period or multi-period analysis, one product or multi-product analysis, and fixed costs or no fixed costs analysis.

3. A method for brand value analysis, the method comprising:
providing a brand value analysis model;
providing model data A based on annual financial information of a brand for a previous year, and model data B based on forecasted annual financial information of the brand for a current year, wherein the financial information includes a unit price for sold goods per volume unit (P_{A}, P_{B}), a number of sold goods based on volume (V_{A}, V_{B}), a production cost per unit C_{A}, C_{B}), a risk adjusted weighted average cost of capital (RA_{A}, RA_{B}), and a net present value multiplier associated with RA_{A}, RA_{B} (D_{A}, D_{B});
calculating with the brand value analysis model a nominal value of future net margin cash-flows CF(A) based on P_{A}, C_{A}, and V_{A}, and CF(B) based on P_{B}, C_{B} and V_{B};
calculating with the brand value analysis model a net present value of cash-flows NCF(A) based on P_{A}, C_{A}, V_{A}, and D_{A}, and NCF(B) based on P_{B}, C_{B}, V_{B}, and D_{B};
calculating with the brand value analysis model a nominal value of future net margin cash-flows CF(A) based on P_{A}, C_{A}, and V_{A}, and CF(B) based on P_{B}, C_{B} and V_{B},
calculating with the brand value analysis model a difference between NCF(A) and NCF(B), as NCF (B−A) based on NCF(A) and NCF(B);
determining with the brand value analysis model increase in product attractivity (PA), increase in market leadership (ML), increase in cost efficiency (CE), and increase in customer loyalty (CL), based on NCF (B−A); and
displaying the calculated and determined results to a user.

4. The method of claim 3, wherein brand value analysis model is configured for one period or multi-period analysis, one product or multi-product analysis, and fixed costs or no fixed costs analysis.

5. A computer program product for brand value analysis and including one or more computer readable instructions embedded on a non-transitory, tangible computer readable medium and configured to cause one or more computer processors to perform the steps of:
providing a brand value analysis model;
providing model data A based on annual financial information of a brand for a previous year, and model data B based on forecasted annual financial information of the brand for a current year, wherein the financial information includes a unit price for sold goods per volume unit (P_{A}, P_{B}), a number of sold goods based on volume (V_{A}, V_{B}), a production cost per unit C_{A}, C_{B}), a risk adjusted weighted average cost of capital (RA_{A}, RA_{B}), and a net present value multiplier associated with RA_{A}, RA_{B} (D_{A}, D_{B});
calculating with the brand value analysis model a nominal value of future net margin cash-flows CF(A) based on P_{A}, C_{A}, and V_{A}, and CF(B) based on P_{B}, C_{B} and V_{B};
calculating with the brand value analysis model a net present value of cash-flows NCF(A) based on P_{A}, C_{A}, V_{A}, and D_{A}, and NCF(B) based on P_{B}, C_{B}, V_{B}, and D_{B};
calculating with the brand value analysis model a nominal value of future net margin cash-flows CF(A) based on P_{A}, C_{A}, and V_{A}, and CF(B) based on P_{B}, C_{B} and V_{B},
calculating with the brand value analysis model a difference between NCF(A) and NCF(B), as NCF (B−A) based on NCF(A) and NCF(B);
determining with the brand value analysis model increase in product attractivity (PA), increase in market leadership (ML), increase in cost efficiency (CE), and increase in customer loyalty (CL), based on NCF (B−A); and
displaying the calculated and determined results to a user.

6. The computer program product of claim 5, wherein brand value analysis model is configured for one period or multi-period analysis, one product or multi-product analysis, and fixed costs or no fixed costs analysis.
